(19) United States
(12) Patent Application Publication
(10) Pub. No.: US 2013/0232372 A1
(43) Pub. Date: Sep. 5, 2013

(54) INTEGRATED CIRCUIT, VOLTAGE VALUE ACQUISITION METHOD, AND TRANSMISSION AND RECEPTION SYSTEM

(71) Applicant: FUJITSU LIMITED, Kawasaki-shi (JP)

(72) Inventors: Hideyuki SAKAMAKI, Yokohama (JP); Yoshikazu Iwami, Inagi (JP)

(73) Assignee: FUJITSU LIMITED, Kawasaki-shi (JP)

(21) Appl. No.: 13/864,749

(22) Filed: Apr. 17, 2013

Related U.S. Application Data
(63) Continuation of application No. PCT/JP2010/069527, filed on Nov. 2, 2010.

(51) Int. Cl. G06F 1/04

(52) U.S. Cl. CPC G06F 1/04
USPC 713/500

(57) ABSTRACT

An integrated circuit includes a data signal reception unit that receives a data signal transmitted from a transmission circuit, a timing signal reception unit that receives a timing signal transmitted from the transmission circuit and indicating a reading timing of the data signal, a timing adjustment unit that adjusts an output timing of the timing signal received by the timing signal reception unit, a reading unit that reads the data signal received by the data signal reception unit according to an adjusted timing signal of which the output timing is adjusted by the timing adjustment unit, and a voltage value acquisition unit that acquires a voltage value of the data signal received by the data signal reception unit and a voltage value of the adjusted timing signal of which the output timing is adjusted by the timing adjustment unit.

### CROSS-REFERENCE TO RELATED APPLICATION

This application is a continuation of International Application No. PCT/JP2010/069527, filed on Nov. 2, 2010 and designating the U.S., the entire contents of which are incorporated herein by reference.

### FIELD

The embodiments discussed herein are relates to an integrated circuit, a voltage value acquisition method, and a transmission and reception system.

### BACKGROUND

In recent years, with the progress of a substrate manufacturing technique or a mounting technique of a Large Scale Integrated Circuit (LSI), an apparatus such as a blade server is known in which a plurality of LSIs such as a plurality of Central Processing Units (CPUs) or main storage devices are mounted on a single board. In this apparatus, since distances of signal lines which connect LSIs to each other are different due to mounting matters, time until a signal transmitted from a transmission side LSI is received by a reception side LSI is unbalanced for each signal. In addition, this unbalance depends on characteristics (a resistance value, a capacitance value, an inductance value, a reflective characteristic of a signal, and the like) of a board wire or a connector, and a performance of a driver (a driving capacity of the driver) embedded in an LSI.

A method is known in which a delay element such as a delay line for each signal is provided inside a reception side LSI as a method for reducing influence of the unbalance and satisfying a timing rule of a data strobe signal for data. In addition, as a method for setting a delay time of the delay element of the reception side LSI, a method is performed in which a waveform of a signal outside the LSI, transmitted from a transmission side LSI to a reception side LSI, is observed using an oscilloscope.

Here, with reference to FIG. 21, a description will be made of an example of observing a waveform of a signal which is transmitted from a Dual Inline Memory Module (DIMM) to a memory controller by using an oscilloscope. As illustrated in FIG. 21, an oscilloscope 300 is provided outside a memory controller 100, and observes a waveform of a signal which is transmitted from a DIMM 200 to the memory controller 100 and is not received by the memory controller 100.

In addition, the DIMM 200 has a driver 201 outputting a Data Queue Strobe (DQS) signal which is a timing signal (strobe signal) when data is received, and a #DQS signal which is an antiphase signal obtained by inverting a phase of the DQS signal. In addition, the DIMM 200 has a driver 202 outputting a Data Queue (DQ) signal which is a data signal to be received. In addition, the memory controller 100 includes a PKG (package) 110 which is an LSI package of the memory controller, a receiver 120 which receives the DQS signal and the #DQS signal, and a receiver 121 which receives the DQ signal.

Further, a plurality of signal lines are provided between the memory controller 100 and the DIMM 200. Specifically, eighteen signal lines for transmitting the DQS signal, eighteen signal lines for transmitting the #DQS signal, and seventy-two signal lines for transmitting the DQ signal are provided. In addition, eighteen receivers 120 which receive the DQS signal and the #DQS signal and seventy-two receivers 121 which receive the DQ signal are provided and are respectively connected to the signal lines. Furthermore, a set of the DQS signal and the #DQS signal is a balanced signal with a balanced relationship, and the #DQS signal obtained by inverting a phase of the DQS signal is transmitted via a single signal line with respect to the DQS signal transmitted via a single signal line.

In addition, DQ signal 4 bits of four signal lines for transmitting the DQ signal corresponds to each bit of the DQS signal and the #DQS signal. In other words, 1 bit of the DQS signal and the #DQS signal indicates a reading timing of the DQ signal corresponding to 4 bits. Further, in relation to the DQ signal, among 72 bits of the DQ signal transmitted via the 72 signal lines, DQ[0] to DQ[63] are data bits, and DQ[64] to DQ[71] are error correction bits used for Error Checking and Correction (ECC).

In addition, the memory controller 100 includes a delay circuit 130 which is a delay element giving a delay time to the DQS signal, a delay circuit 131 which gives a delay time to the DQ signal, and a delay value control circuit 140 which sets a delay time in the delay elements. Further, hereinafter, a signal which is output from the delay circuit 130 is referred to as a “delayed DQS signal”, and a signal which is output from the delay circuit 131 is referred to as a “delayed DQ signal”. Furthermore, the memory controller 100 includes a Flip Flop (FF) 150 and an FF 151 which reads the delayed DQ signal in response to the delayed DQS signal, an inverter 160 which is a negative logical circuit inverting the delayed DQS signal, and a data synchronization circuit 170 which synchronizes data of the FF 150 and the FF 151 which are operated at a frequency of the delayed DQS signal. Here, the data synchronization circuit 170 is a circuit which transfers data between different frequencies by synchronizing data output by the FF 150 and the FF 151 which are operated at a frequency of the delayed DQS/delayed #DQS signal with an embedded clock of the memory controller 100 which has a higher frequency than the frequency of the delayed DQS/delayed #DQS signal.

With this configuration, the DIMM 200 transmits the DQS signal which is a timing signal (strobe signal) from the driver 201 in response to a READ command from the memory controller 100, and transmits the DQ signal which is a data signal from the driver 202. In addition, the DQ signal and the DQS signal output from the DIMM 200 are input to the FF 150 via a connector of the DIMM 200, wires of the system board, wires in the PKG 110 inside the memory controller 100, and the circuits such as the receivers 120 and 121 and the delay circuits 130 and 131. Thereafter, the FFs 150 and 151 read the delayed DQ signal by using the delayed DQS signal which has passed through the delay circuit 130 as a clock signal.

In addition, when the DQ signal and the DQS signal are transmitted and received between the DIMM 200 and the memory controller 100, waveforms of the DQ signal and the DQS signal which are transmitted from the DIMM 200 and are not received by the memory controller 100 can be observed using the oscilloscope 300. Here, the DQ signal and the DQS signal which can be observed using the oscilloscope 300 are a DQ signal and a DQS signal before being input to the delay circuits 130 and 131 of the memory controller 100.
Patent Literature 1: Japanese Laid-open Patent Publication No. 2006-99676

However, in the method in which a waveform of the signal transmitted from the transmission device to the reception device is observed using the oscilloscope, there is a problem in that it is difficult to know whether or not the delayed DQS signal which is a timing signal after being output from the delay element inside the reception device satisfies a timing rule of a setup time and a hold time. In other words, the oscilloscope is provided outside the reception device and thus does not observe a waveform of an input signal inside the reception, and it is difficult to know whether or not a reading timing of the delayed DQ signal for the delayed DQS signal after being output from the delay element inside the reception device satisfies the timing rule of the setup time and the hold time. In addition, the above-described problem is not limited to communication between the DIMM and the memory controller and is a problem common to the devices transmitting and receiving a signal.

### SUMMARY

According to an aspect of an embodiment, an integrated circuit includes a data signal reception unit that receives a data signal transmitted from a transmission circuit, a timing signal reception unit that receives a timing signal transmitted from the transmission circuit and indicating a reading timing of the data signal, a timing adjustment unit that adjusts an output timing of the timing signal received by the timing signal reception unit, a reading unit that reads the data signal received by the data signal reception unit according to an adjusted timing signal of which the output timing is adjusted by the timing adjustment unit, and a voltage value acquisition unit that acquires a voltage value of the data signal received by the data signal reception unit and a voltage value of the adjusted timing signal of which the output timing is adjusted by the timing adjustment unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration of a DIMM and a memory controller related to First Embodiment;

FIG. 2 is a diagram illustrating a connection relationship between the DIMM and the memory controller;

FIG. 3 is a diagram illustrating a standard interface of DDR SDRAM;

FIG. 4 is a diagram illustrating a data format of a DQ signal;

FIG. 5 is a diagram illustrating an internal structure of a delay circuit;

FIG. 6 is a block diagram illustrating an internal structure of a data synchronization circuit;

FIG. 7 is a diagram illustrating a timing chart of the data synchronization circuit;

FIG. 8 is a diagram illustrating output timings of the DQ signal and the DQS signal;

FIG. 9 is a block diagram illustrating a detailed configuration of a waveform gathering control unit;

FIG. 10 is a block diagram illustrating an internal structure of an A/D converter;

FIG. 11 is a diagram illustrating operation timings of the A/D converter and the memory;

FIG. 12 is a diagram illustrating an example of the data stored in the memory;

FIG. 13 is a diagram illustrating reception waveforms of the DQS signal and the DQ signal;

FIG. 14 is a diagram illustrating reception waveforms of the DQS signal and the DQ signal when setup is insufficient;

FIG. 15 is a diagram illustrating reception waveforms of the DQS signal and the DQ signal when a hold time is insufficient;

FIG. 16 is a diagram illustrating an eye pattern of the DQ signal;

FIG. 17 is a diagram illustrating an eye pattern when amplitude is abnormal;

FIG. 18 is a flowchart illustrating a process operation of the memory controller related to First Embodiment;

FIG. 19 is a flowchart illustrating a process operation of the memory controller related to First Embodiment;

FIG. 20 is a flowchart illustrating a process operation of a Personal Computer (PC) which displays reception waveforms collected by the memory controller related to First Embodiment; and

FIG. 21 is a block diagram illustrating a configuration of a DIMM and a memory controller in the related art.

### DESCRIPTION OF EMBODIMENTS

Preferred embodiments of the present invention will be explained with reference to accompanying drawings. In addition, this invention is not limited to these embodiments.

### [a] First Embodiment

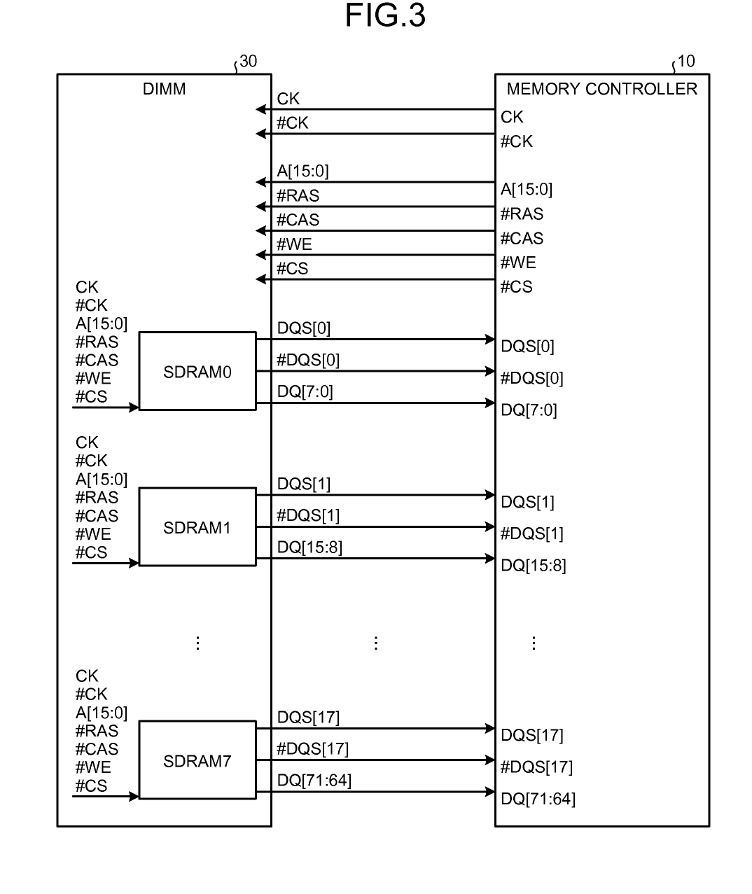

In the following embodiment, a configuration and a process flow of a memory controller related to First Embodiment will be described in order, and effects by First Embodiment will be described finally. In addition, in the following, a description will be made an example of the case where a Dual Inline Memory Module (DIMM) transmits a DQ signal which is a data signal and a DQS signal which is a timing signal (strobe signal) to a memory controller as response signals to a READ command (details thereof will be described later in FIG. 3) from the memory controller 10. Further, in the memory controller related to First Embodiment, a Double Data Rate Synchronous Dynamic Random Access Memory (DDR SDRAM) which enables the DQ signal which is synchronized with both rising and falling edges of the DQS signal to be received by the memory controller is employed.

### Configuration of Memory Controller Related to First Embodiment

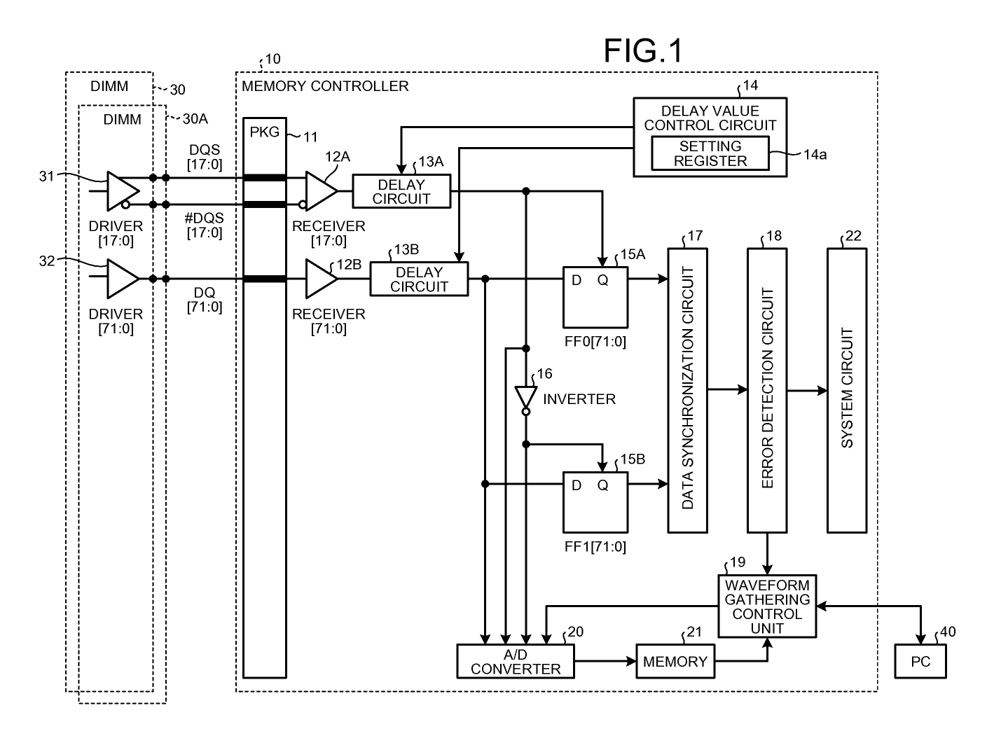

First, with reference to FIG. 1, a configuration of the memory controller related to First Embodiment will be described. FIG. 1 is a block diagram illustrating a configuration of the memory controller related to First Embodiment. As illustrated in FIG. 1, the memory controller 10 is connected to two DIMMs 30 and 30A and a Personal Computer (PC) 40.

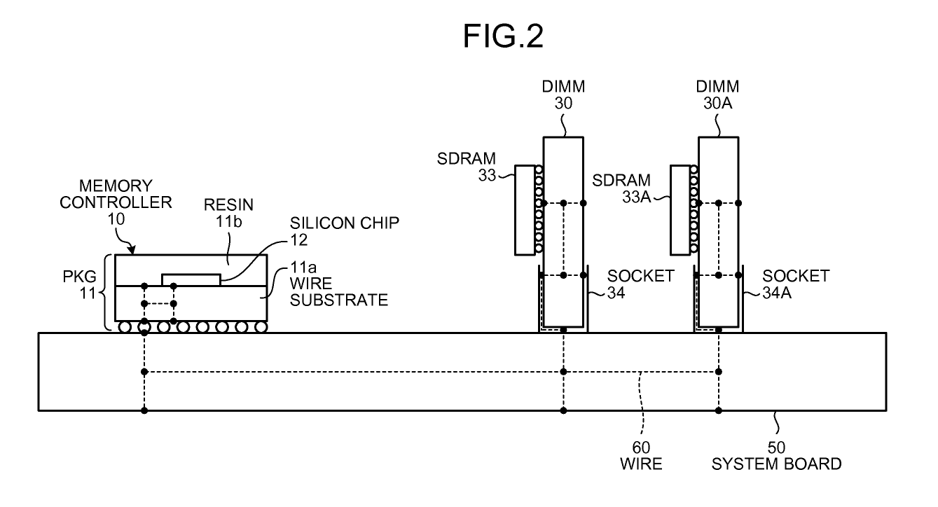

Here, with reference to FIG. 2, a description will be made of a connection relationship between the memory controller 10 and the DIMMs 30 and 30A. FIG. 2 is a diagram illustrating a connection relationship between the DIMM and the memory controller. As illustrated in FIG. 2, the memory controller 10 and the DIMMs 30 and 30A are mounted on a system board 50 and are connected to each other via a wire 60. The memory controller 10 is an LSI in which a silicon chip 12 sealed with a resin 11b is mounted on a wire substrate 11a. In addition, hereinafter, the resin 11b covering the silicon chip 12 and the wire substrate 11a for wire-connection of the silicon chip 12 are collectively referred to as a PKG (package) 11.

In addition, the DIMM 30 (30A) has a Synchronous Dynamic Random Access Memory (SDRAM) 33 (33A) mounted thereon as illustrated in FIG. 2. When a READ command is acquired from the memory controller 10, the SDRAM 33 (33A) outputs a DQ signal which is data corresponding to an address included in the READ command and a DQS signal in the same phase to the memory controller 10. In addition, DQ[71:0] from the DIMM 30 and DQ[71:0] from the DIMM 30A form dot coupling. Further, a socket 34 (34A) is installed in the system board 50, and the socket 34 (34A) electrically connects the DIMM 30 (30A) to the system board 50.

Here, a standard interface of DDR SDRAM will be described with reference to FIG. 3. FIG. 3 is a diagram illustrating a standard interface of DDR SDRAM. In the example of FIG. 3, an UNBUFFERED DIMM type of DDR DIMM is illustrated as an example of the standard interface of DDR SDRAM. As illustrated in FIG. 3, the memory controller 10 transmits a clock signal “CK”, an antiphase signal “#CK” obtained by inverting a phase of the clock signal, and a signal “A[15:0]” for designating a row or a column of an address, to the DIMM 30, as READ commands. In addition, the memory controller 10 transmits “#Row Address Strobe (RAS)” indicating that an address designated by A[15:0] is a row when active, and “#Column Address Strobe (#CAS)” indicating that an address designated by A[15:0] is a column when active, to the DIMM 30, as READ commands. In addition, the memory controller 10 transmits “#Write Enable (#WE)” which is a read/write designation signal and is in a READ mode when inactive, and “#Chip Select (#CS)” which makes an input signal valid when active, to the DIMM 30.

In addition, as illustrated in FIG. 3, the DIMM 30 has eight SDRAMs 0 to 7. Each SDRAM receives the READ commands (the above-described “CK”, “#CK”, “A[15:0]”, “#RAS”, “#CAS”, “#WE”, and “#CS”) from the memory controller 10. In addition, the respective SDRAMs 0 to 7 transmit a DQS signal of 1 bit, #DQS signal of 1 bit, and a DQ signal of 8 bits to the memory controller 10 in response to the READ commands.

Referring to FIG. 1 again, the DIMM 30 includes a driver 31 which transmits a DQS signal and a driver 32 which transmits a DQ signal. The DIMM 30 transmits a DQ signal which is a data signal, a DQS signal which is a clock signal, and a #DQS signal which is an antiphase signal obtained by inverting a phase of the DQS signal, to the memory controller 10, as response signals to the READ commands.

Specifically, the DIMM 30 transmits the DQS signal from the driver 31 to the memory controller 10, for example, via wires with a bit width of 18 bits. In addition, the driver 31 also transmits the #DQS signal obtained by inverting the DQS signal to the memory controller 10 together with the DQS signal. Further, the #DQS signal is a signal transmitted to the memory controller 10 so as to detect noise that is mixed with the DQS signal due to crosstalk. 1 bit of the DQS signal/#DQS signal in a single signal line for transmitting the DQS signal/#DQS signal corresponds to 4 bit of the DQ signal in four signal lines for transmitting the DQ signal. In other words, 1 bit of the DQS signal and the #DQS signal indicates a reading timing of the DQ signal corresponding to 4 bits.

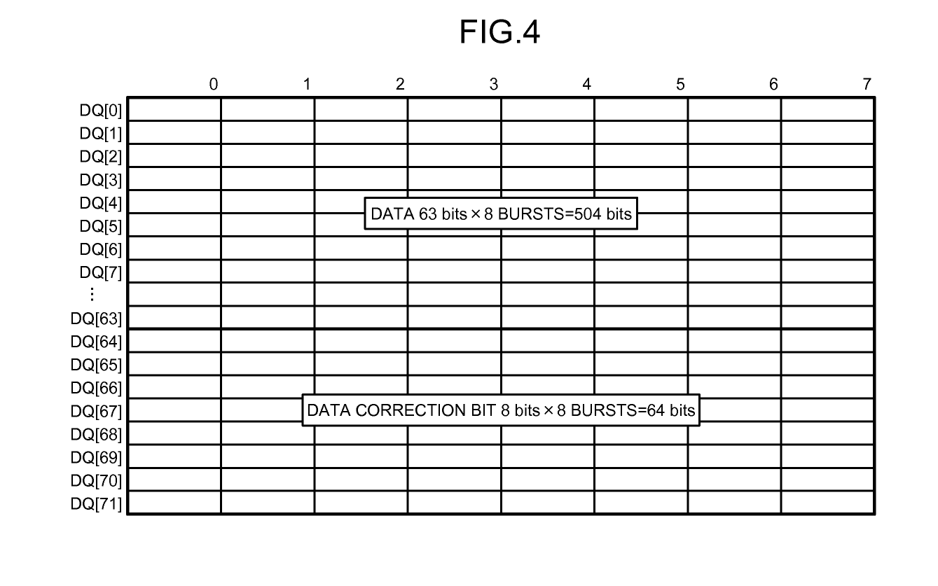

In addition, the DIMM 30 transmits the DQ signal from the driver 32 to the memory controller 10, for example, via wires with a bit width of 72 bits. Further, for example, among data items of 72 bits transmitted from the driver 32, 64 bits are data items for the READ commands, and 8 bits are data items for error correction. Here, a data format of the DQS signal will be described specifically with reference to FIG. 4. As illustrated in FIG. 4, among 72 data signals DQ, DQ[0] to DQ[63] are data bits, and DQ[64] to DQ[71] are error correction bits. In addition, when a burst length is set to BL=8 in the DIMM 30, eight data items are continuously read in one reading.

The memory controller 10 includes the PKG 11, a receiver 12A, a receiver 12B, a delay circuit 13A, a delay circuit 13B, a delay value control circuit 14, a flip flop (FF) 15A, an FF 15B, and an inverter 16. In addition, the memory controller 10 includes a data synchronization circuit 17, an error detection circuit 18, a waveform gathering control unit 19, and an Analog to Digital (A/D) converter 20, a memory 21, and a system circuit 22.

The PKG 11 is connected to the DIMM 30 via wires provided therebetween, and receives a DQ signal and a DQS signal from the DIMMs 30 and 30A. Specifically, the package 11, as illustrated in FIG. 2, includes the wire substrate 11a and the resin 11b, protects the silicon chip 12 by blocking external influence, and wire-connects the silicon chip 12 on the system board 50.

The receiver 12A receives a DQS signal and a #DQS signal. Specifically, the receiver 12A receives the DQS signal and the #DQS signal from the DIMMs 30 and 30A via the wires provided in the wire substrate 11a of the PKG 11, obtains a difference with a difference signal of the received DQS signal and the #DQS signal so as to recover an original DQS signal which is output to the delay circuit 13A.

The receiver 12B receives a DQ signal. A bus width of the DQ signal received by the receiver 12B is 72 bits, and a bus width of the DQS signal is 18 bits. 1 bit of the DQS signal corresponds to 4 bits of the DQ signal. Specifically, the receiver 12B receives the DQ signal from the DIMMs 30 and 30A via the wires provided in the wire substrate 11a of the PKG 11, and outputs the received DQ signal to the delay circuit 13B.

The delay circuit 13A adjusts an output timing of the DQS signal received by the receiver 12A. Specifically, the delay circuit 13A delays the DQS signal output from the receiver 12A so as to be output to the FF 15A, the inverter 16, and the A/D converter 20. The delay circuit 13B adjusts an output timing of the DQ signal received by the receiver 12B. The delay circuit 13B delays the DQ signal received by the receiver 12B so as to be output to the FF 15A, the FF 15B, and the A/D converter 20. In addition, the delay circuits 13A and 13B are assumed to absorb the unbalance of a delay time which occurs until the DQ signal and the DQS signal transmitted from the DIMMs 30 and 30A arrive at the memory controller 10. Further, the unbalance here refers to both the delay unbalance between the same signals such as the DQ signals or the DQS signals, and the delay unbalance between the DQ signal and the DQS signal.

The delay value control circuit 14 sets a delay time in the delay circuits 13A and 13B. Specifically, the delay value control circuit 14 includes a setting register 14a which stores a setting value of a delay time received from an external terminal. In addition, the delay value control circuit 14 sets a delay time in the delay circuits 13A and 13B such that a timing of a delayed DQS signal satisfies a timing rule of a setup time and a hold time, according to the setting value of the delay time stored by the setting register 14a.

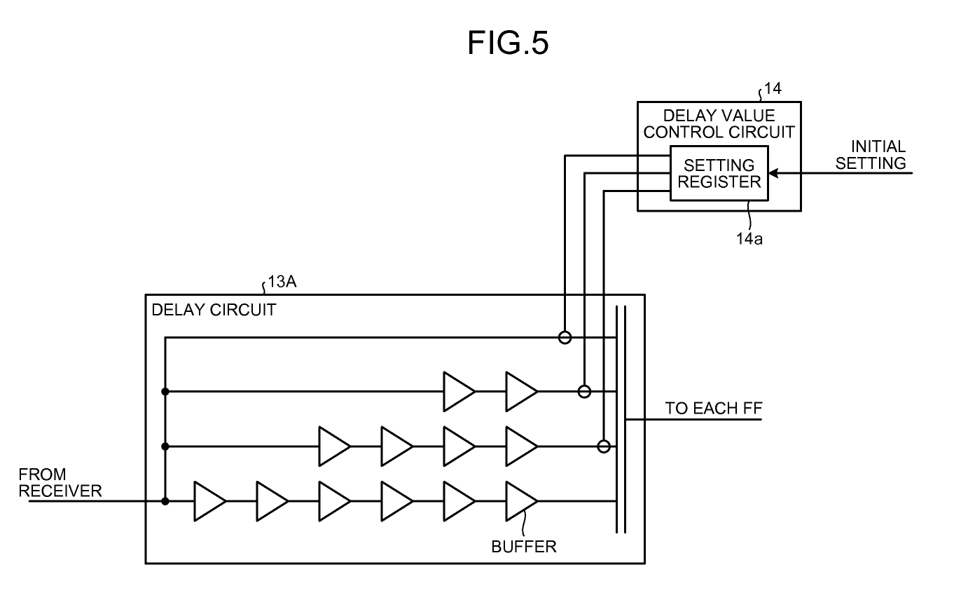

Here, the delay circuit 13A and the delay value control circuit 14 will be described in detail with reference to FIG. 5. FIG. 5 is a diagram illustrating an internal structure of the delay circuit. As illustrated in FIG. 5, the delay circuit 13A includes a plurality of paths in which the number of stages of buffers are delay elements which delays the DQS signal by making the DQS signal pass through any one path. In addition, with respect to the bit width “18” of the DQS signal, the eighteen delay circuits 13A are provided. Further, with respect to the bit width “72” of the DQ signal, the seventy-two delay circuits 13B are provided.

In addition, in the example of FIG. 5, it is assumed that an initial setting of a delay time is input to the delay value control circuit 14 from an external terminal in advance, and a setting value of the delay time is stored in the setting register 14a. Further, the delay value control circuit 14 selects a signal path through which the DQS signal input from the receiver 12A passes and controls a delay time of the DQS signal, according to the setting value of the delay time stored in the setting register 14a. Furthermore, although FIG. 5 illustrates an example of the delay circuit 13A, the delay circuit 13B also has the same configuration as the delay circuit 13A, and a delay time is controlled by the delay value control circuit 14.

The FF 15A reads a delayed DQ signal output by the delay circuit 13B in synchronization with rising of the delayed DQS signal output by the delay circuit 13A. Specifically, the FF 15A reads the delayed DQ signal when a voltage value of the delayed DQS signal output by the delay circuit 13A exceeds a predetermined threshold value, and outputs the read delayed DQ signal to the data synchronization circuit 17.

In addition, the inverter 16 inverts the delayed DQS signal which is input from the delay circuit 13A, so as to be output to the FF 15B. The FF 15B reads the delayed DQ signal output by the delay circuit 13B in synchronization with rising of the delayed DQS signal output by the inverter 16. Specifically, the FF 15B reads the delayed DQ signal when a voltage value of the delayed DQS signal output by the inverter 16 exceeds a predetermined threshold value, and outputs the read delayed DQ signal to the data synchronization circuit 17.

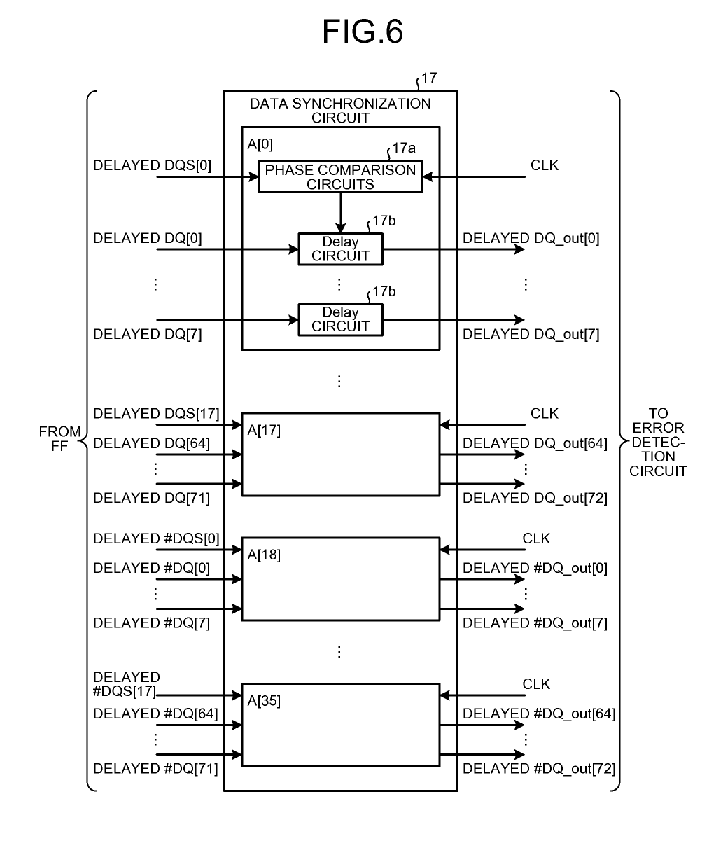

The data synchronization circuit 17 synchronizes the data output from the FF 15A and the data from the FF 15B with an embedded clock thereof so as to be output to the error detection circuit 18. Here, a detailed configuration of the data synchronization circuit will be described with reference to FIG. 6. As illustrated in FIG. 6, the data synchronization circuit 17 includes a plurality of phase comparison circuits 17a and a plurality of delay circuits 17b. In the data synchronization circuit 17, the thirty-six phase comparison circuits 17a are provided, and the eight delay circuits 17b are connected to each of the phase comparison circuits 17a. Further, the data synchronization circuit 17 receives the delayed DQS[17:0] with the bus width of 18 bits which is output from the FF 15A, and delayed #DQS[17:0] with the bus width of 18 bits which is inverted by the inverter 16 and is output from the FF 15B. Furthermore, the data synchronization circuit 17 receives the delayed DQ[71:0] with the bus width of 72 bits which is output from the FF 15A, and delayed #DQ [71:0] with the bus width of 72 bits which is output from the FF 15B.

The phase comparison circuits 17a compares a phase of the delayed DQS signal or the delayed #DQS signal output from the FFs 15A and 15B with a phase of a clock signal CLK of the memory controller 10, obtains a difference between CLK and the delayed DQS signal, and inputs the difference between CLK and the delayed DQS signal to the delay circuits 17b as a setting value. In addition, the delay circuits 17b gives a delay time to the delayed DQ signal such that the delayed DQ signal is synchronized with the clock signal of the memory controller 10, and outputs the delayed DQ signal to the error detection circuit 18.

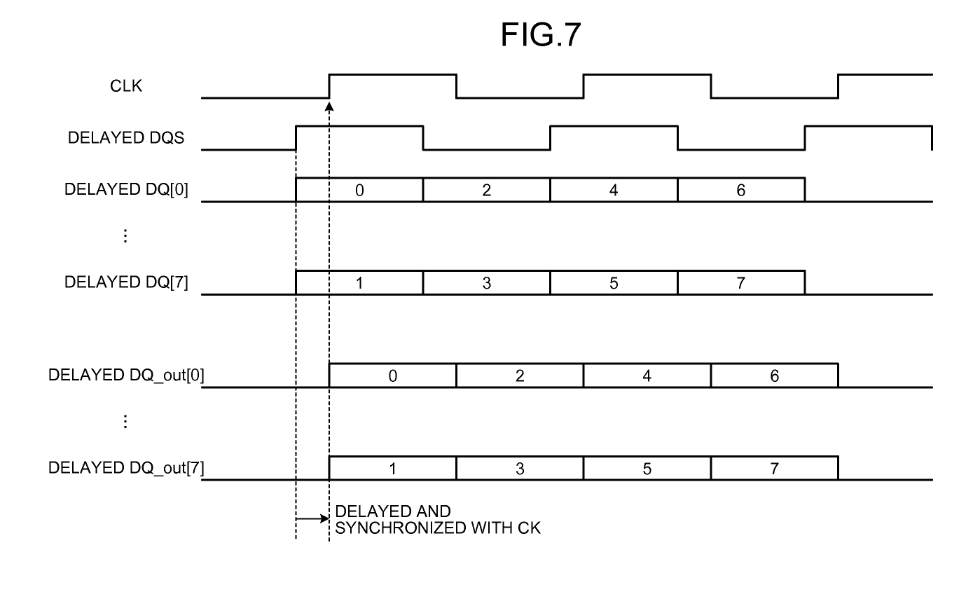

Here, a synchronization process by the data synchronization circuit will be described with reference to FIG. 7. FIG. 7 is a diagram illustrating a timing chart of the data synchronization circuit. As illustrated in FIG. 7, the data synchronization circuit 17 obtains a difference between the delayed DQS signal and the clock signal CLK, and the delay circuits 17b delays the delayed DQ signal by the difference so as to be synchronized with the clock signal CLK.

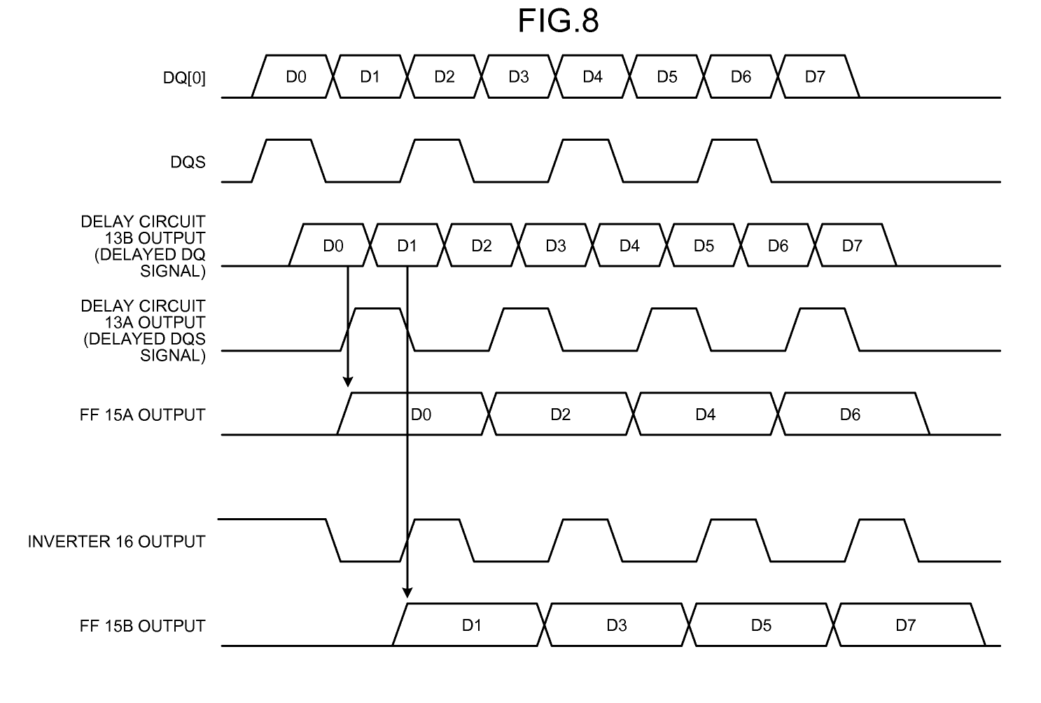

Here, output timings of the DQ signal and the DQS signal will be described with reference to FIG. 8. FIG. 8 is a diagram illustrating output timings of the DQ signal and the DQS signal. In the example of FIG. 8, a waveform of “DQ[0]” is a waveform (in the example of FIG. 8, a waveform of the first bit among 72 bits) of the DQ signal received from the DIMM 30. A waveform of “DQS” is a waveform of the DQS signal received from the DIMM 30, and a waveform of “delay circuit 13B output” is a waveform (a waveform of the first bit among 72 bits) of the delayed DQ signal which is output from the delay circuit 13B. In addition, a waveform of “delay circuit 13A output” is a waveform of the delayed DQS signal which is output from the delay circuit 13A, and a waveform of “FF 15A output” is a waveform of the delayed DQ signal which is output from the FF 15A. Further, a waveform of “inverter output” is a waveform of the delayed DQS signal which is output from the inverter 16, and a waveform of “FF 15B output” is a waveform of the delayed DQ signal which is output from the FF 15B. Furthermore, in FIG. 8, the longitudinal axis expresses a voltage value, and the transverse axis expresses time, and, the same transverse axis indicates the same time axis.

As exemplified in FIG. 8, “DQS” which is received from the DIMM 30 is input to the delay circuit 13A, is delayed by 90 degrees, and is then output as the delayed DQS signal from the delay circuit 13A. In addition, the delayed DQ signal is read to the FF 15A at a timing when a voltage value of the delayed DQS signal output from the delay circuit 13A is equal to or more than a predetermined threshold value, and is output to the data synchronization circuit 17 from the FF 15A. When described using the example of FIG. 8, the FF 15A reads the data “D0”, “D2”, “D4”, and “D6” of the delayed DQ signal so as to be output to the data synchronization circuit 17 at a timing when a voltage value of the delayed DQS signal output from the delay circuit 13A is equal to or more than a predetermined threshold value.

In addition, the delayed DQ is read to the FF 15B at a timing when the delayed DQS signal which is inverted by the inverter 16 is equal to or more than a predetermined threshold value, and is output to the data synchronization circuit 17 from the FF 15B. When described using the example of FIG. 8, the FF 15B reads the data “D1”, “D3”, “D5”, and “D7” of the delayed DQ signal so as to be output to the data synchronization circuit 17 at a timing when a voltage value of the delayed DQS signal inverted by the inverter 16 is equal to or more than a predetermined threshold value.

The error detection circuit 18 detects that the FF 15A or the FF 15B has failed to read the delayed DQ signal. Specifically, the error detection circuit 18 detects whether or not there is an error in the delayed DQ signals read from the FFs 15A and 15B by using error correction data included in the delayed DQ signals, and transmits a notification indicating that errors are detected to the waveform gathering control unit 19 when the errors are detected. In addition, the error detection circuit 18 detects errors of data of the first bit to the 64th bit by using the error correction data included in the 65th bit to the 72nd bit of the delayed DQ signal. In addition, the system circuit 22 is provided at the rear stage of the error detection circuit 18. The system circuit 22 uses data in which it is confirmed that there is no error by the error detection circuit 18.

The waveform gathering control unit 19 controls an operation of the A/D converter 20 which samples a reception waveform of the delayed DQS output from the delay circuit 13A and a voltage value of the delayed DQ signal output from the delay circuit 13B. Specifically, when the information indicating errors are detected from the error detection circuit 18, the waveform gathering control unit 19 controls an operation of the A/D converter 20 so as to a voltage value of the delayed DQ signal and a voltage value of the delayed DQS signal when reading failure occurs. Further, a sampling frequency of the A/D converter 20 is 7.5 picosecond (ps).

For example, when the DIMM 30 is initially shipped, the waveform gathering control unit 19 starts an operation of the A/D converter 20 and makes the A/D converter 20 sample voltage values of the delayed DQ signal and the delayed DQS signal and transmit the sampled values to the memory 21 in a case where an M-th error is detected in the error detection circuit 18. Successively, the waveform gathering control unit 19 stops an operation of the A/D converter 20 and transmits the data accumulated in the memory 21 to the PC 40 in a case where an N-th error is detected in the error detection circuit 18.

In other words, since errors frequently occur when the DIMM 30 is initially shipped, an operation of the A/D converter 20 is not operated so as to wait for an operation of the DIMM 30 to be stabilized until the M-th error is detected, and an operation of the A/D converter 20 starts after the M-th error is detected. Here, the reason why errors frequently occur when the DIMM is initially shipped is that there are cases where quality of the DIMM is not constant and thus an operation is unstable in the initial shipment. In addition, the reason why an operation of the A/D converter 20 does not start until the M-th error is detected is that, since an operation thereof is not stabilized immediately after an operation of the DIMM 30 starts but errors particularly frequently occur, an operation of the DIMM 30 is awaited to be stabilized for a while after the operation thereof starts, and then the A/D converter 20 is operated. Thereby, even when the DIMM is initially shipped, it is possible to sample voltage values of the delayed DQ signal and the delayed DQS signal which are influenced by an unbalance of a delay time due to the PKG 11 or the delay circuits 13A and 13B inside the memory controller 10. In addition, the above-described method of sampling a voltage value in the circumstances in which an operation of the DIMM is unstable is hereinafter referred to as a “first collection method”.

In addition, for example, in a case where a producing amount of the DIMM becomes constant and thus quality of the DIMM is stabilized, the waveform gathering control unit 19 starts an operation of the A/D converter 20 so as to gather data which is transmitted to the memory 21 when the start of an operation is received from the PC 40. Further, in a case where errors are detected in the error detection circuit 18, an operation of the A/D converter 20 stops, and the data accumulated in the memory 21 is transmitted to the PC 40.

In other words, in circumstances in which a producing amount of the DIMM becomes constant, an operation of the A/D converter 20 starts before errors occur in order to handle a DIMM in which only several errors occur for a long time. Here, the reason why several errors occur for a long time if a producing amount of the DIMM becomes constant is that quality of the DIMM is also stabilized at the same time as a producing amount of the DIMM becoming constant.

In addition, when errors occur, an operation of the A/D converter 20 stops, and the accumulated data which is accumulated in the memory 21 and is sampled by the A/D converter 20 is transmitted to the PC 40. Further, the above-described method of sampling a voltage value in the circumstances in which a producing amount of the DIMM becomes constant is hereinafter referred to as a “second collection method”. Furthermore, whether to perform sampling of a voltage value using the first collection method or to perform sampling of a voltage value using the second collection method is determined by the waveform gathering control unit 19 receiving operation settings from the PC 40.

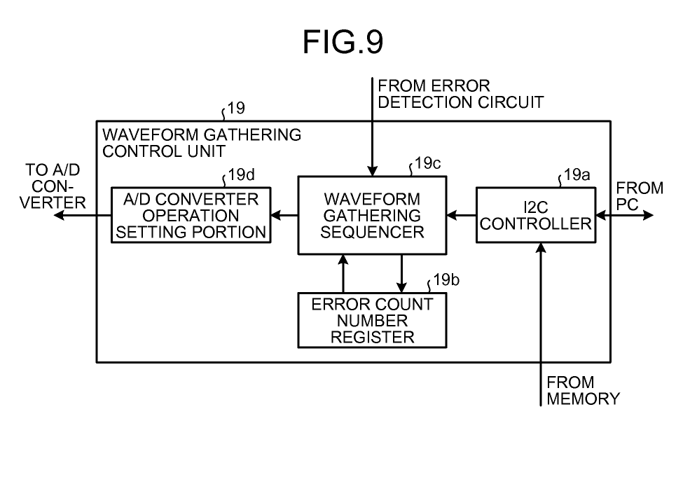

Here, a detailed configuration of the waveform gathering control unit 19 will be described with reference to FIG. 9. As illustrated in FIG. 9, the waveform gathering control unit 19 includes an Inter-Integrated Circuit (I2C) controller 19a, an error count number register 19b, a waveform gathering sequencer 19c, and an A/D converter operation setting portion 19d.

The I2C controller 19a controls communication with the PC 40. Specifically, the I2C controller 19a receives an instruction regarding whether the above-described first collection method or second collection method is performed as an operation setting, or specific content of a start condition or a stop condition of an operation of the A/D converter 20, from the PC 40. In addition, the I2C controller 19a transmits data of the delayed DQ signal and the delayed DQS signal read from the memory 21, to the PC 40. The error count number register 19b stores the number of errors detected by the error detection circuit 18.

In a case of sampling a voltage value through the first collection method, the waveform gathering sequencer 19c notifies the A/D converter operation setting portion 19d of an instruction for starting of an operation of the A/D converter 20 when the number of errors stored in the error count number register 19b is M. Thereafter, the waveform gathering sequencer 19c notifies the A/D converter operation setting portion 19d of an instruction for stopping of an operation of the A/D converter 20 when the number of errors stored in the error count number register 19b is N.

In addition, in a case of sampling a voltage value through the second collection method, the waveform gathering sequencer 19c notifies the A/D converter operation setting portion 19d of an instruction for starting of an operation of the A/D converter 20 when the starting of an operation is received from the PC 40. Then, when errors are detected in the error detection circuit 18, the A/D converter operation setting portion 19d is notified of an instruction of stopping of an operation of the A/D converter 20.

When the instruction for starting of an operation of the A/D converter 20 is received from the waveform gathering sequencer 19c, the A/D converter operation setting portion 19d sets starting of an operation for the A/D converter 20. In addition, when the instruction for stopping of an operation of the A/D converter 20 is received, the A/D converter operation setting portion 19d sets stopping of an operation for the A/D converter 20.

The A/D converter 20 converts the gathered delayed DQ signal and delayed DQS signal into voltage values, respectively, for each predetermined time, and stores the converted values in the memory 21. Specifically, when the instruction for starting of an operation is received from the waveform gathering control unit 19, the A/D converter 20 starts an operation of converting the delayed DQ signal output from the delay circuit 13B and the delayed DQS signals output from the delay circuit 13A and the inverter 16 into voltage values, respectively, for each predetermined time (for example, 7.5 picosecond (ps)). In addition, the A/D converter 20 converts the gathered delayed DQ signal and the delayed DQS signal into voltage values, respectively, and stores the converted voltage values in the memory 21.

Further, when the instruction for stopping of an operation is received from the waveform gathering control unit 19, the A/D converter 20 stops the operation of gathering a voltage value of the delayed DQ signal output from the delay circuit 13B and voltage values of the delayed DQS signals output from the delay circuit 13A and the inverter 16.

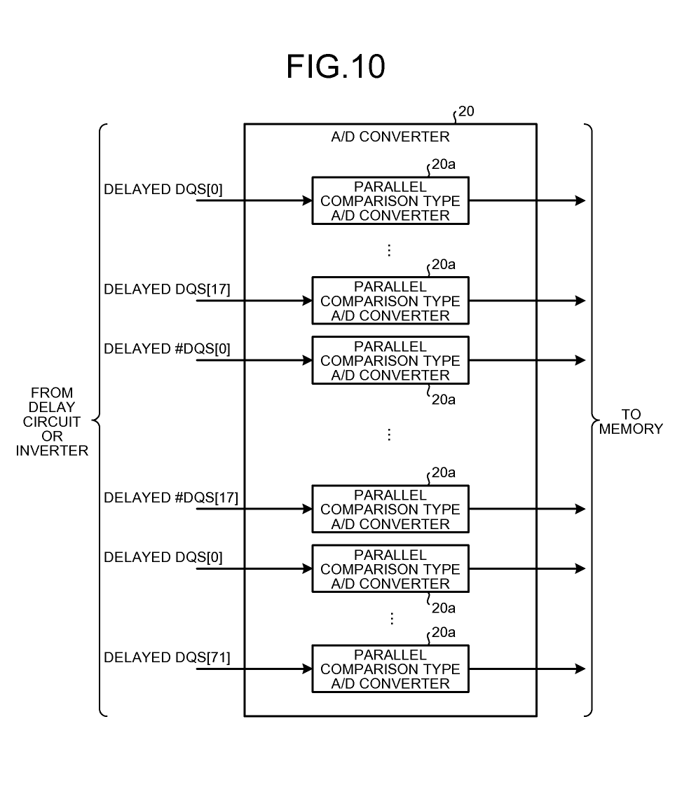

Here, a detailed configuration of the A/D converter 20 will be described with reference to FIG. 10. As illustrated in FIG. 10, the A/D converter 20 includes a plurality of parallel comparison type A/D converters 20a. In the A/D converter 20, a bus width of the delayed DQS signal received from the delay circuit 13A is 18 bits, a bus width of the delayed #DQS signal received from the inverter 16 is 18 bits, and the delayed DQ signal received from the delay circuit 13B is 72 bits. The 108 parallel comparison type A/D converters 20a are provided, and receive the respective bits of the delayed DQS signal, the delayed #DQS signal and the delayed DQ signal. The respective parallel comparison type A/D converters 20a receive the delayed DQS signal, the delayed #DQS signal, and the delayed DQ signal, so as to be converted into voltage values, respectively, and stores the converted voltage values in the memory 21.

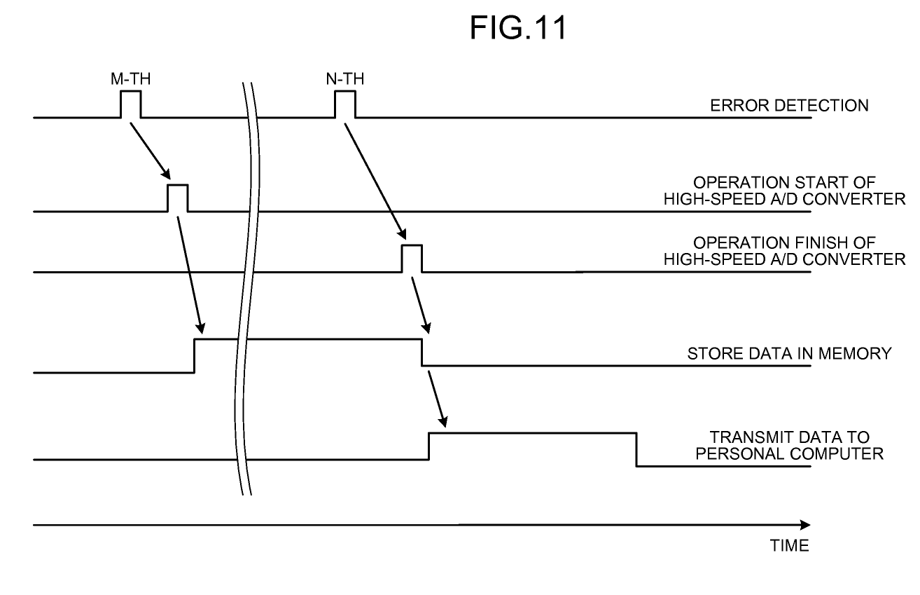

Here, operation timings of the A/D converter 20 and the memory 21 will be described with reference to FIG. 11. FIG. 11 is a diagram illustrating operation timings of the A/D converter and the memory. In FIG. 11, operation timings of the A/D converter 20 and the memory 21 will be described using an example of the first collection method. As illustrated in FIG. 11, when the M-th error is detected by the error detection circuit 18, the A/D converter 20 starts an operation of gathering voltage values of the delayed DQ signal and the delayed DQS signal. In addition, the A/D converter 20 finishes the operation of gathering voltage values of the delayed DQ signal and the delayed DQS signal while writing data in the memory 21, when the N-th error is detected by the error detection circuit 18.

In addition, the A/D converter 20 stores the voltage values of the delayed DQ signal and the delayed DQS signal gathered until the operation finishes after the operation starts, in the memory 21. Thereafter, the waveform gathering control unit 19 reads the voltage values of the delayed DQ signal and the delayed DQS signal stored as memory data, so as to be transmitted to the PC 40.

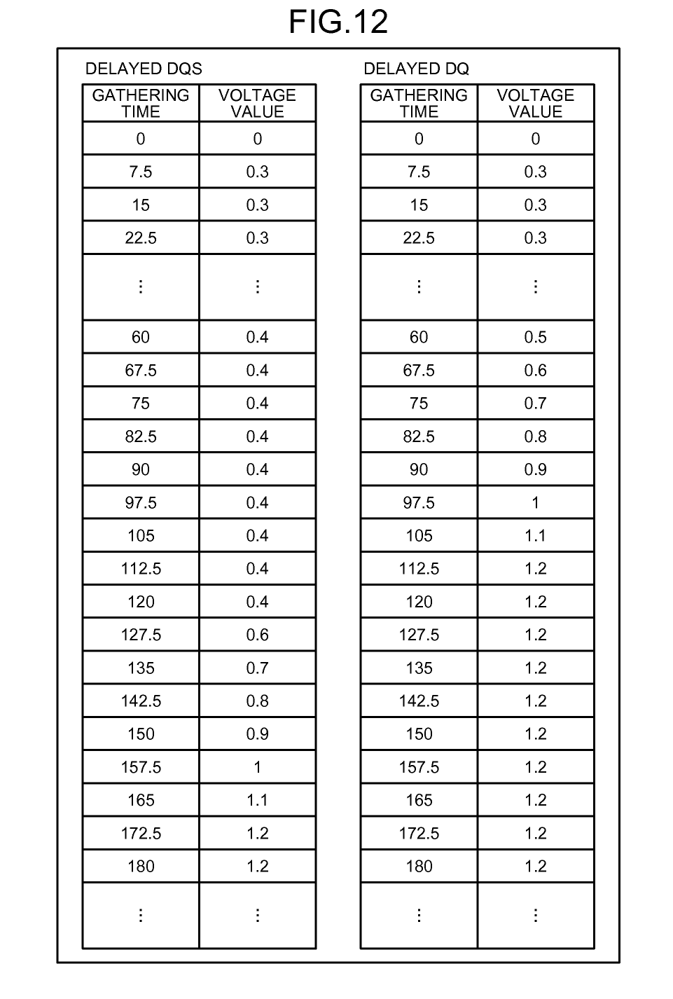

The memory 21 stores the voltage values of the delayed DQ signal and the delayed DQS signal converted by the A/D converter 20. Specifically, the memory 21, as illustrated in FIG. 12, stores a “gathering time” indicating an elapsed time after the A/D converter 20 starts an operation and a “voltage value” indicating a value of a voltage of the delayed DQ signal or the delayed DQS signal in correlation with each other, for the respective delayed DQS signal and the delayed DQS signal. In addition, the unit of a value of the gathering time is “picosecond (ps)”, and the unit of a voltage value is “volt (V)”. FIG. 12 is a diagram illustrating an example of the data stored in the memory.

The PC 40 receives data regarding the voltage values of the delayed DQ signal and the delayed DQS signal from the memory controller 10, and displays reception waveforms of the delayed DQ signal and the delayed DQS signal by using the received data. Specifically, when the gathering time and voltage values stored in the memory 21 of the memory controller 10 are received from the waveform gathering control unit 19, the PC 40 displays reception waveforms of the delayed DQ signal and the delayed DQS signal by using the gathering time and the voltage values.

In addition, the PC 40 calculates a setup time and a hold time of the delayed DQ signal with respect to rising of the reception waveform of the delayed DQS signal, and determines whether or not the setup time and the hold time are insufficient in the timing rule of DDR SDRAM.

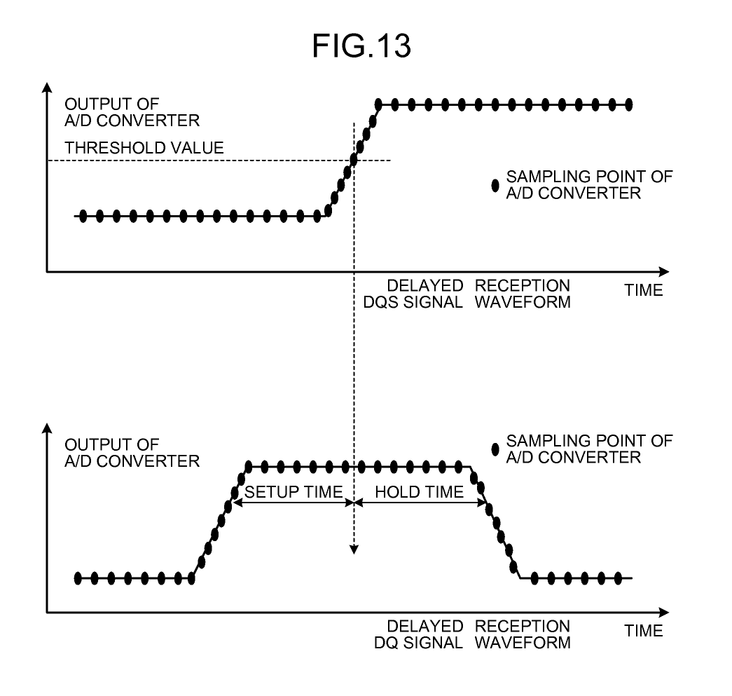

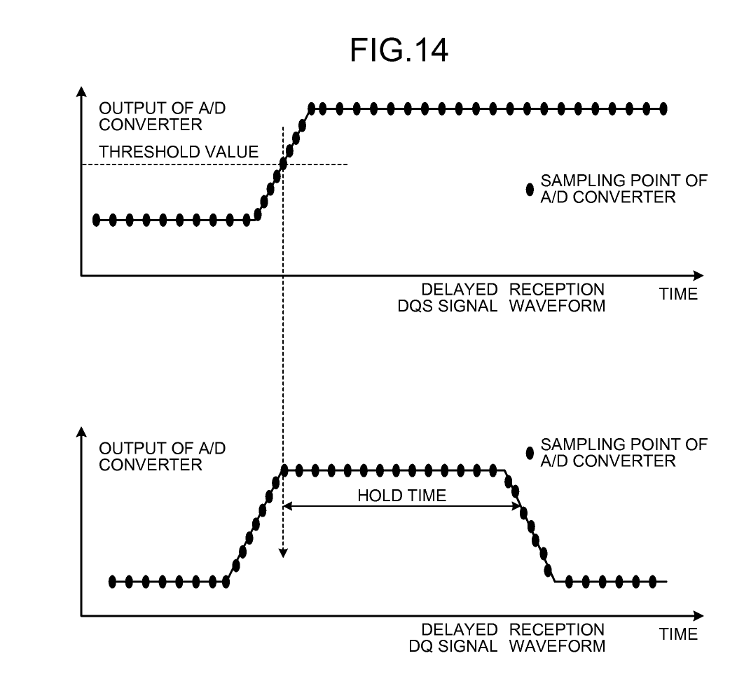

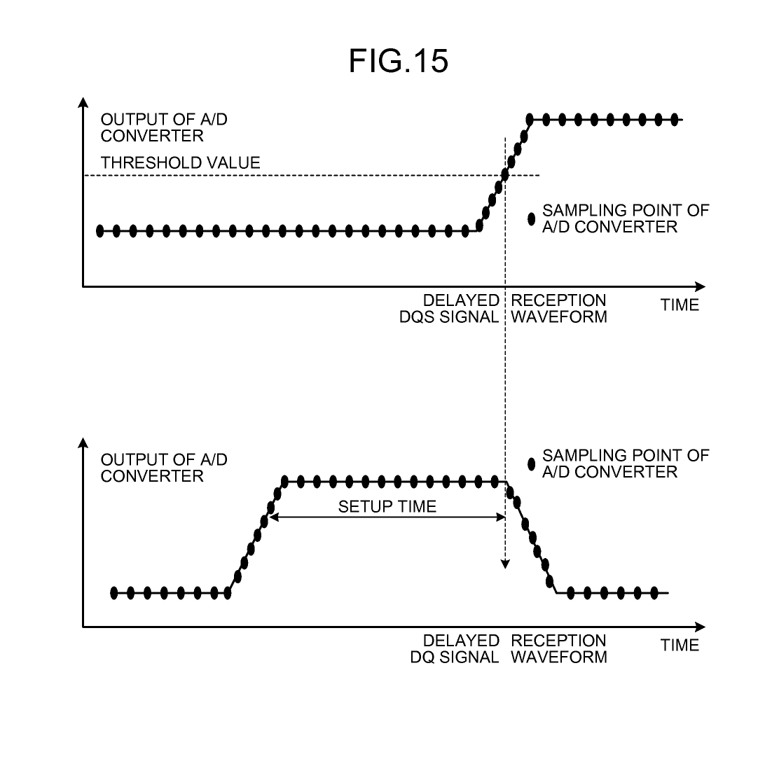

Here, cases where the setup time and the hold time of the delayed DQ signal are sufficient and insufficient for the delayed DQS signal will be described using examples of FIGS. 13 to 15. FIG. 13 is a diagram illustrating reception waveforms of a DQS signal and a DQ signal. FIG. 14 is a diagram illustrating reception waveforms of a DQS signal and a DQ signal when setup is insufficient. FIG. 15 is a diagram illustrating reception waveforms of a DQS signal and a DQ signal when the hold time is insufficient. In addition, in FIGS. 13 to 15, the longitudinal axis expresses a voltage value, and the transverse axis expresses time.

For example, as illustrated in FIG. 13, since a sufficient time has elapsed after the delayed DQ signal rises, and there is a predetermined time until the DQ signal falls, at the timing when the voltage value of the DQS signal exceeds the threshold value, the PC 40 determines that the setup time and the hold time are sufficient. In other words, since the delayed DQ signal is read from the FFs 15A and 15B at the timing when the voltage value of the delayed DQS signal exceeds the threshold value, in the example of FIG. 13, it can be confirmed that the setup time and the hold time are secured, and the FFs 15A and 15B can appropriately read the delayed DQ signal.

In addition, in the example of FIG. 14, the PC 40 determines that the setup time is insufficient since the reception waveform of the delayed DQ signal rises at the timing when the voltage value of the delayed DQS signal exceeds the threshold value. Further, in the example of FIG. 15, the PC 40 determines that the hold time is insufficient since the reception waveform of the delayed DQ signal falls at the timing when the voltage value of the delayed DQS signal exceeds the threshold value.

In other words, the PC 40 displays a reception waveform of the delayed DQ signal and a reception waveform of the delayed DQS signal received from the memory controller 10 and thereby can observe whether or not the delayed DQ signal and each delayed DQS signal satisfy the timing rule of DDR SDRAM. In addition, the PC 40 determines whether or not the setup time and the hold time are insufficient. As a result, in a case where the setup time or the hold time is insufficient, it can be determined that reading error of the FFs 15A and 15B is caused by an unbalance of a delay time inside the memory controller 10.

In addition, for example, the PC 40 may display a reception waveform of the delayed DQ signal in an eye pattern, calculate window widths tup and tdown for threshold values Vth and Vt1, and check whether or not the window widths tup and tdown are insufficient. Further, the threshold value Vth is a voltage level for detecting rising of the delayed DQ signal, and the threshold value Vt1 is a voltage level for detecting falling of the delayed DQ signal. Here, the eye pattern is to display sampled voltage values of the delayed DQ signal in a time series. In addition, the window width tup refers to a time width when a voltage value of the delayed DQ signal is higher than the threshold value Vth, and the window width tdown refers to a time width when a voltage value of the delayed DQ signal is lower than the threshold value Vt1.

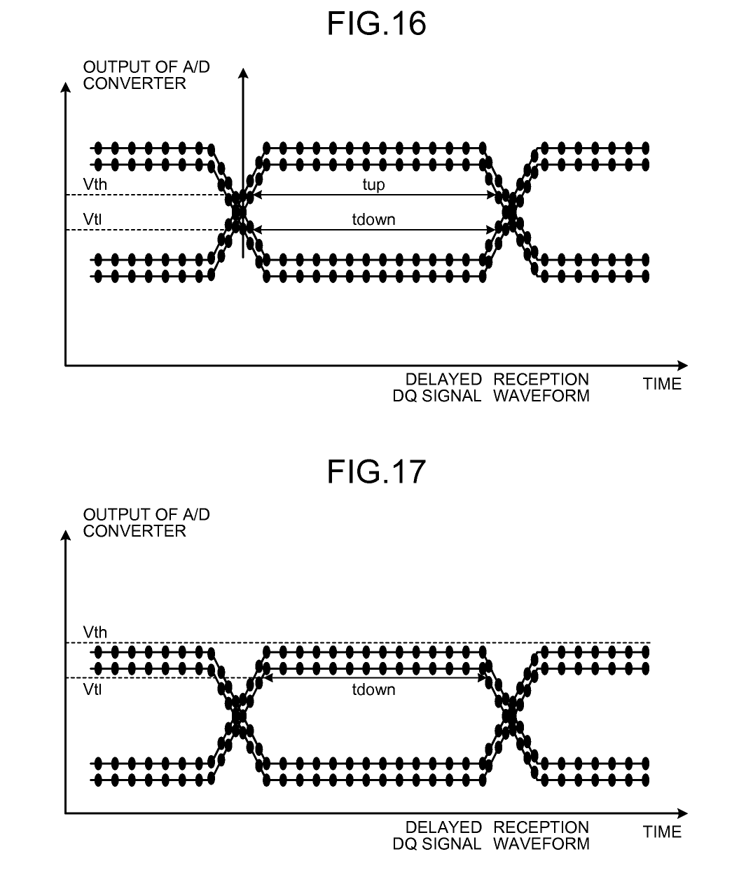

Here, cases where the setup time and the hold time of the delayed DQ signal are sufficient and insufficient in the timing rule of DDR SDRAM will be described using examples of FIGS. 16 and 17. FIG. 16 is a diagram illustrating an eye pattern of the delayed DQ signal. FIG. 17 is a diagram illustrating an eye pattern of the delayed DQ signal when amplitude is abnormal.

In the example of FIG. 16, the PC 40 determines that time widths of the window widths tup and tdown for the threshold values Vth and Vt1 are sufficient in a reception waveform of the delayed DQ signal. In contrast, in the example of FIG. 17, since the voltage value of the delayed DQ signal is lower than the threshold value Vth due to abnormal amplitude, the PC 40 does not detect rising of the delayed DQ signal and determines that a time width of the window width tup for the threshold value Vth is insufficient. In other words, in the example of FIG. 17, since rising of the delayed DQ signal is not detected, the FFs 15A and 15B read erroneous data from the delayed DQ signal.

In other words, the PC 40 displays reception of the delayed DQ signal received from the memory controller 10 and thereby may observe whether or not the delayed DQ signal satisfies the timing rule of DDR SDRAM for the delayed DQS signal. In addition, the PC 40 determines whether or not the window widths tup and tdown are insufficient, and can determine that the reading error of the FFs 15A and 15B is caused by errors in only the DIMM 30, if window widths tup and tdown are insufficient.

Process by Memory Controller

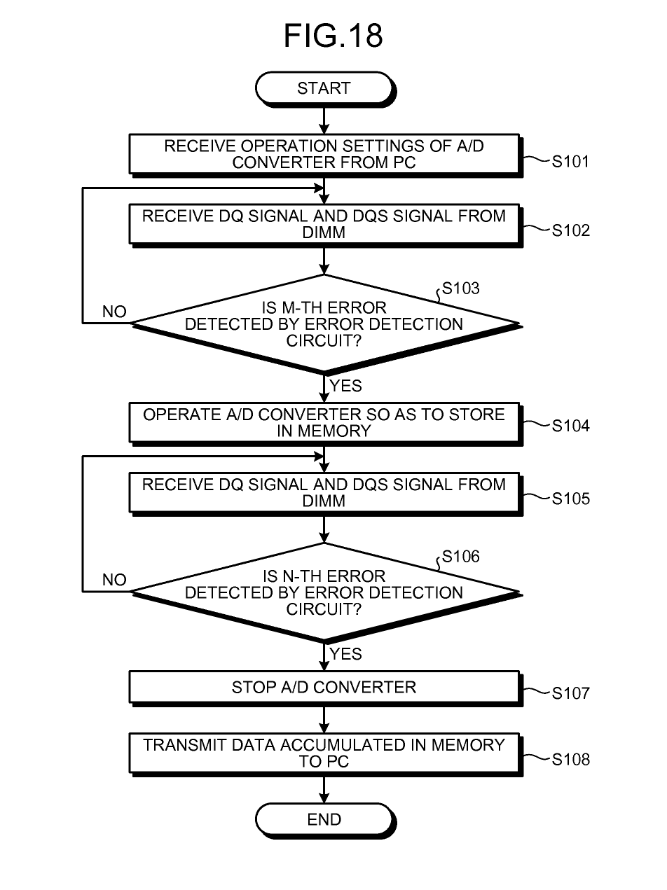

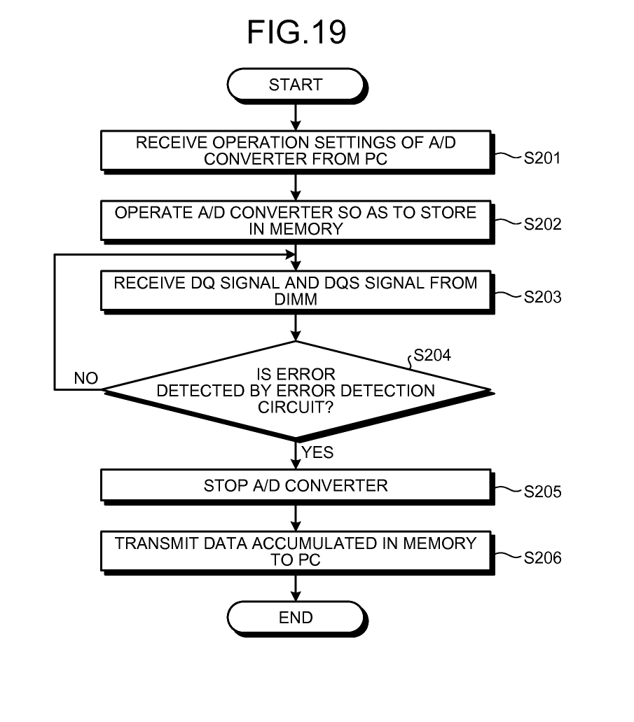

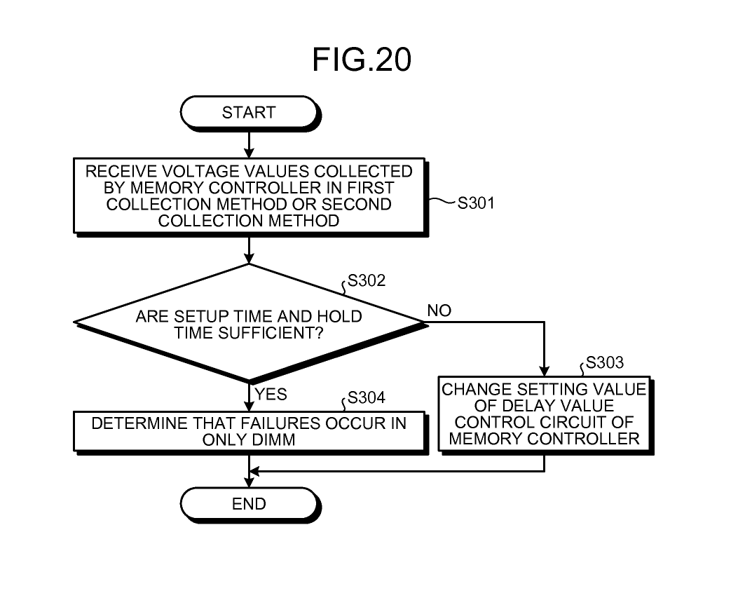

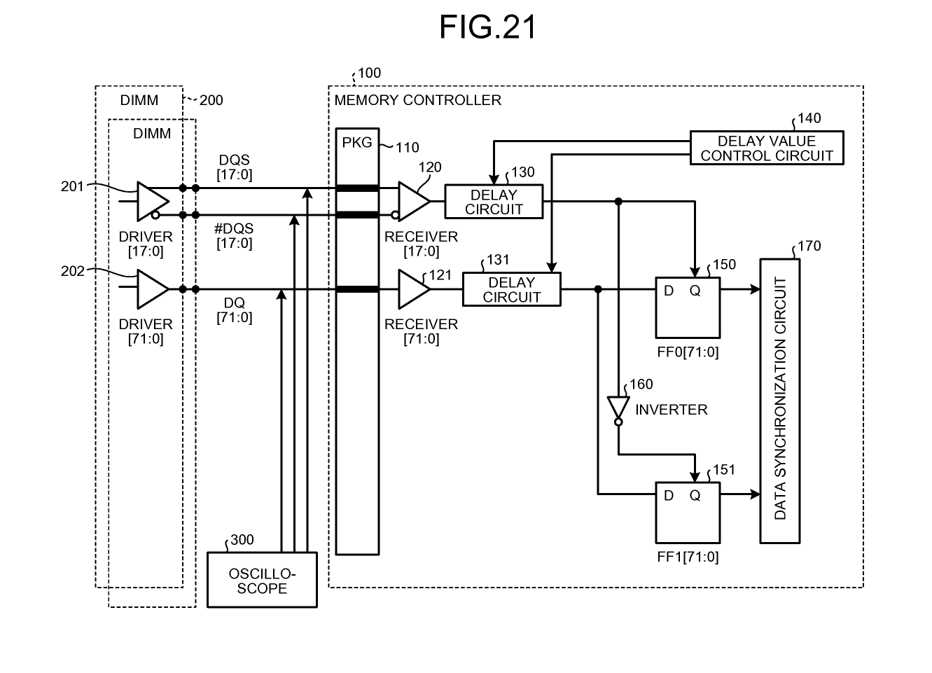

Next, with reference to FIGS. 18 to 20, processes of the first collection method and the second collection method by the memory controller 10 and the PC 40 related to First Embodiment. FIGS. 18 and 19 are flowcharts respectively illustrating process operations of the first collection method and the second collection method by the memory controller 10 related to First Embodiment. FIG. 20 is a flowchart illustrating a process operation of the PC which displays reception waveforms collected by the memory controller related to First Embodiment.

As illustrated in FIG. 18, the memory controller 10 receives operation settings of the A/D converter 20 from the PC 40 (step S101), and starts to receive a DQ signal and a DQS signal from the DIMM 30 (step S102).

In addition, the waveform gathering control unit 19 determines whether or not an M-th error is detected by the error detection circuit 18 (step S103). As a result, if the waveform gathering control unit 19 determines that the M-th error is not detected by the error detection circuit 18 (No in step S103), the memory controller 10 returns to S102, and continuously performs the process of receiving the DQ signal and the DQS signal from the DIMM 30.

In addition, if it is determined that the M-th error is detected by the error detection circuit 18 (Yes in step S103), the waveform gathering control unit 19 operates the A/D converter 20 so as to store sampled voltage values of the delayed DQ signal and the delayed DQS signal in the memory 21 (step S104). Further, the memory controller 10 performs a process of receiving the DQ signal and the DQS signal from the DIMM 30 (step S105). Furthermore, the waveform gathering control unit 19 determines whether or not an N-th error is detected by the error detection circuit 18 (step S106).

As a result, if the waveform gathering control unit 19 determines that the N-th error is not detected by the error detection circuit 18 (No in step S106), the memory controller 10 returns to S105, and continuously performs the process of receiving the DQ signal and the DQS signal from the DIMM 30. In addition, if it is determined that the N-th error is detected by the error detection circuit 18 (Yes in step S106), the waveform gathering control unit 19 stops the A/D converter 20 (step S107). Further, the waveform gathering control unit 19 reads the data accumulated in the memory 21 so as to be transmitted to the PC 40 (step S108).

Next, a reception waveform collection process by the memory controller according to the second collection method will be described. Specifically, when operation settings of the A/D converter 20 are received from the PC 40 (step S201), the memory controller 10 operates the A/D converter 20 so as to store voltage values of the delayed DQ signal and the delayed DQS signal in the memory 21 (step S202). In addition, the memory controller 10 performs a process of receiving the DQ signal and the DQS signal from the DIMM 30 (step S203).

In addition, the waveform gathering control unit 19 determines whether or not an error is detected by the error detection circuit 18 (step S204). As a result, if the waveform gathering control unit 19 determines that an error is not detected by the error detection circuit 18 (No in step S204), the memory controller 10 returns to S203, and continuously performs the process of receiving the DQ signal and the DQS signal from the DIMM 30. Here, the error refers to an error in which erroneous data detected by the error correction code (ECC) is transmitted.

In addition, if it is determined that the error is detected by the error detection circuit 18 (Yes in step S204), the waveform gathering control unit 19 stops the A/D converter 20 (step S205). Further, the waveform gathering control unit 19 reads the data accumulated in the memory 21 so as to be transmitted to the PC 40 (step S206).

Next, a description will be made of an operation of the PC 40 which displays voltage values collected by the memory controller 10. The PC 40 receives the voltage values of the delayed DQ signal and the voltage values of the delayed DQS signal, collected using the first collection method or the second collection method, from the memory controller 10 (step S301). In addition, the PC 40 determines whether or not the setup time and the hold time are sufficient based on the voltage values of the delayed DQ signal and the voltage values of the delayed DQS signal (step S302).

As a result, if it is determined that the setup time and the hold time of the delayed DQ signal are not sufficient for the delayed DQS signal in the timing rule of DDR SDRAM (No in step S302), the PC 40 regards that a cause of the error is in the memory controller 10 and changes a setting value of the delay value control circuit 14 of the memory controller 10 (step S303). In addition, if it is determined that the setup time and the hold time are sufficient (Yes in step S302), the PC 40 determines that a cause of the error is in only the DIMM (step S304).

### Effects of First Embodiment

As described above, the memory controller 10 includes the receiver 12A which receives a DQ signal transmitted from the DIMM 30, and the receiver 12B which receives a DQS signal indicating a reading timing of a data signal, transmitted from the transmission circuit. In addition, the memory controller 10 includes the delay circuit 13A which adjusts an output timing of the received timing signal. Further, the memory controller 10 reads a DQ signal according to a delayed DQS signal of which the output timing is adjusted by the delay circuit 13A. Furthermore, the memory controller 10 acquires a voltage value of the delayed DQ signal and a voltage value of the delayed DQS signal. For this reason, it is possible to understand signal waveforms from the voltage values of the delayed DQ signal and the delayed DQS signal inside the memory controller and to thereby understand whether or not a timing of the delayed DQ signal satisfies the timing rule of the setup time and the hold time.

In addition, according to First Embodiment, the memory controller 10 detects that there is an error in the DQ signal, and acquires a voltage value of the DQ signal and a voltage value of an adjusted timing signal in a case where it is detected a predetermined number of times that there is an error in the DQ signal. As a result, even in a case where errors frequently occur when the DIMM 30 is initially shipped, it is possible to appropriately understand whether or not a timing of the delayed DQ signal satisfies the timing rule of the setup time and the hold time.

In addition, according to First Embodiment, in a case where it is detected that there is an error in the DQ signal, the memory controller 10 acquires a voltage value of the DQ signal and a voltage value of the delayed DQS signal when it is detected that there is an error in a data signal. As a result, even in a case where quality of the DIMM is stable, it is possible to appropriately understand whether or not a timing of the delayed DQ signal satisfies the timing rule of the setup time and the hold time.

Further, according to First Embodiment, the memory controller 10 outputs voltage values of the DQ signal and voltage values of the DQS signal collected by the A/D converter 20, to the PC 40. As a result, the PC 40 displays a waveform of the DQ signal and a waveform of the DQS signal, and thereby it is possible to determine whether a cause of an error is in the memory controller 10 or the DIMM 30. For example, in a case where there is a data reading error in the memory controller 10, the PC 40 can determine that timing failures causing the error occur due to unbalance of a delay time inside the memory controller if the setup time and the hold time are not sufficient. In addition, if the setup time and the hold time are sufficient, the PC 40 can determine that DIMM failures causing an error in data output by the DIMM occur.

### [b] Second Embodiment

Although First Embodiment has been described hitherto, in addition to the above-described embodiment, various other forms may be employed. Therefore, hereinafter, as Second Embodiment, other embodiments included in the present embodiment will be described.

(1) Test Pattern

Circumstantial states of the DIMM and the memory controller may be changed, a DQ signal and a DQS signal transmitted from the DIMM may be converted into voltage values, respectively, in a state in which the circumstantial states of the DIMM and the memory controller are changed, and the converted voltage values may be stored in the memory.

Specifically, a predetermined test pattern is written in the DIMM in advance. In addition, the memory controller issues a READ command to the DIMM so as to read the test pattern from the DIMM. Here, when the memory controller reads the test pattern, circumstantial states of the DIMM and the memory controller are changed.

In addition, in a state where the circumstances are changed, the memory controller converts a delayed DQ signal and a delayed DQS signal output from the delay circuits into voltage values, respectively, and stores the converted voltage values in the memory.

For example, when the memory controller reads the test pattern, circumstantial states are changed by increasing a peripheral temperature of the DIMM and the memory controller. As above, in a case of increasing the peripheral temperature of the DIMM and the memory controller, an error may occur such as change in data. In a state in which the error due to the circumstantial variation occurs, the delayed DQ signal and the delayed DQS signal inside the memory controller may be converted into voltage values, respectively, and the converted voltage values may be stored in the memory 21.

(2) Transmission and Reception Device

Although, in First Embodiment, a description has been made of an example of the case where transmission and reception of a signal are performed between the DIMM and the memory controller, the present invention is not limited thereto, and is applicable to various devices as long as the devices perform transmission and reception of a signal without being limited to the DIMM and the memory controller.

(3) Memory

Although, in First Embodiment, a description has been made of an example of the case where data gathered by the A/D converter is stored in the memory and the data stored in the memory is transmitted to the PC, the present invention is not limited thereto, and the data gathered by the A/D converter may be directly transmitted to the PC without providing the memory.

(4) System Configuration and the Like

In addition, each illustrated constituent element of each device is functional and conceptual, and is not necessary to be physically configured as illustrated. In other words, a specific form of distribution and integration of the respective devices is not limited to that illustrated, and all or some thereof may be configured through functional or physical distribution or integration with any units according to various loads, use circumstances, or the like. For example, the data synchronization circuit 17 and the error detection circuit 18 may be integrated. Further, all or any of the respective process functions performed by the respective devices may be realized by a CPU and a program which is interpreted and executed by the CPU, or may be realized in hardware using wired logic.

According to an aspect of the integrated circuit disclosed in the present specification, an effect is achieved in which it is possible to understand whether or not an output of a timing signal satisfies a timing rule of a setup time and a hold time.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An integrated circuit comprising:
a data signal reception unit that receives a data signal transmitted from a transmission circuit;
a timing signal reception unit that receives a timing signal transmitted from the transmission circuit and indicating a reading timing of the data signal;
a timing adjustment unit that adjusts an output timing of the timing signal received by the timing signal reception unit;
a reading unit that reads the data signal received by the data signal reception unit according to an adjusted timing signal of which the output timing is adjusted by the timing adjustment unit; and
a voltage value acquisition unit that acquires a voltage value of the data signal received by the data signal reception unit and a voltage value of the adjusted timing signal of which the output timing is adjusted by the timing adjustment unit.

2. The integrated circuit according to claim 1, further comprising:
a detection unit that detects that there is an error in the data signal read by the reading unit,
wherein the voltage value acquisition unit acquires the voltage value of the data signal and the voltage value of the adjusted timing signal, when the detection unit detects a predetermined number of times that there is an error in the data signal.

3. The integrated circuit according to claim 1, further comprising:
a detection unit that detects that there is an error in the data signal read by the reading unit,
wherein the voltage value acquisition unit acquires the voltage value of the data signal and the voltage value of the adjusted timing signal at a time of being detected that there is an error in the data signal, when the detection unit detects that there is an error in the data signal.

4. A voltage value acquisition method comprising:
receiving a data signal transmitted from a transmission circuit and a timing signal indicating a reading timing of the data signal;
adjusting an output timing of the received timing signal;
reading the data signal according to an adjusted timing signal of which the output timing is adjusted;
detecting that there is an error in the read data signal; and
acquiring a voltage value of the data signal and a voltage value of the adjusted timing signal, when it is detected a predetermined number of times that there is an error in the data signal.

5. The voltage value acquisition method according to claim 4, wherein the acquiring includes acquiring the voltage value of the data signal and the voltage value of the adjusted timing signal at a timing of being detected that there is an error in the data signal, when it is detected that there is an error in the data signal.

6. A transmission and reception system comprising:
a transmission circuit that transmits a data signal and a timing signal indicating a reading timing of the data signal;
an integrated circuit that receives the data signal and the timing signal and reads the data signal according to the timing signal,
wherein the transmission circuit includes:
a data signal transmission unit that transmits the data signal to the integrated circuit; and
a timing signal transmission unit that transmits the timing signal to the integrated circuit, and
wherein the integrated circuit includes
a data signal reception unit that receives the data signal transmitted from the data signal transmission unit;
a timing signal reception unit that receives the timing signal transmitted from the timing signal transmission unit and indicating a reading timing of the data signal;
a timing adjustment unit that adjusts an output timing of the timing signal received by the timing signal reception unit;
a reading unit that reads the data signal received by the data signal reception unit according to an adjusted timing signal of which the output timing is adjusted by the timing adjustment unit; and
a voltage value acquisition unit that acquires a voltage value of the data signal received by the data signal reception unit and a voltage value of the adjusted timing signal of which the output timing is adjusted by the timing adjustment unit.
